(19) United States
(12) Patent Application Publication
(10) Pub. No.: US 2006/0190229 A1
(43) Pub. Date: Aug. 24, 2006

(54) METHOD OF MODELING A PORTION OF AN ELECTRICAL CIRCUIT USING A POLE-ZERO APPROXIMATION OF AN S-PARAMETER TRANSFER FUNCTION OF THE CIRCUIT PORTION

(75) Inventors: Faraydon Pakbaz, Milton, VT (US); Amanullah Mohammad, Essex Junction, VT (US)

Correspondence Address: DOWNS RACHLIN MARTIN PLLC, 199 MAIN ST, PO BO 190, BURLINGTON, VT, 05402-0190, US

(73) Assignee: INTERNATIONAL BUSINESS MACHINES CORPORATION, Armonk, NY (US)

(21) Appl. No.: 10/906,509

(22) Filed: Feb. 23, 2005

(51) Int. Cl. G06F 17/50

(52) U.S. Cl. 703/14

(57) ABSTRACT

A method (1100) of creating a behavioral model of a portion (400) of an electrical circuit. The method includes collecting data by measuring an S-parameter of the circuit portion. A transfer function approximation (412, 1000) is then constructed from the S-parameter data. The transfer function approximation is simplified to provide a partial fraction expansion (416). The behavioral model includes a passive filter (420, 1004) designed to represent the partial fraction expansion.

### FIELD OF THE INVENTION:

The present invention generally relates to the field of electronics. In particular, the present invention is directed to a method of modeling a portion of an electrical circuit using a pole-zero approximation of an S-parameter transfer function of the circuit portion.

### BACKGROUND OF THE INVENTION:

With the continuing integration of electronics, more and more frequently multiple integrated circuit chips are required to communicate with one another, often over relatively large distances through communication interconnects. At the same time, the speeds of these chips and the communication between/among them are also increasing. As communication speeds increase, it is increasingly important to match the impedance of each communication interconnect with the impedance of the communication ports at the ends of the interconnect. Consequently, it is now vitally important to accurately model the interconnect in order to optimize the design of the overall system.

FIG. 1 shows a multi-chip system 100 that includes two chips 104, 106 mounted on a printed circuit board (PCB) 110. The two chips 104, 106 communicate with one another over a communication interconnect 114 on PCB 110 via corresponding high-speed serializer/deserializer (SerDes) circuitries 118, 120 onboard the chips. In this case, the length of communication interconnect 114 is on the order, e.g., of several inches. In other systems, the length of the communication interconnect(s) may be much greater, e.g., on the order of tens of inches or more.

One conventional method of modeling communication interconnects is to model them using the classic telegrapher's transmission line equation developed in the 1800s. Referring to FIG. 2, this method generally involves modeling an interconnect as a series of circuit segments in which each segment 200 includes a resistor 204, an inductor 208, a capacitor 212 and a gain 216. The resulting series of segments may then be entered into virtually any circuit simulator, such as SPICE, for simulation. Resistance (R), inductance (I), capacitance (C) and gain (K) values, all of which are a function of frequency, are extracted directly from scattering (S) parameter measurement data as a function of the propagation constant y and characteristic impedance Z of the interconnect. For more detailed information regarding this method, see William R. Eisenstadt and Yungseon Eo, “S-Parameter-Based Interconnect Transmission Line Characterization” IEEE Transactions on Components, Hybrids, and Manufacturing Technology, Vol. 15, No. 4 (August 1992), which is incorporated by reference herein in its entirety.

The number of segments into which a communication interconnect is segmented is generally a function of the design frequency of the interconnect—the higher the frequency, the greater the number of segments. In the Eisenstadt paper mentioned above, the authors found it sufficient to partition a 1 cm interconnect into ten 1 mm segments for simulation up to about 5 GHz or so. A ten-segment model is reasonable in terms of the time it takes to run simulations. However, models for interconnect designed to operate at similar or higher frequencies but which are longer than 1 cm become cumbersome in simulations. For example, in a recently-developed multi-chip system, one of the communication interconnects between two chips was 40 inches. Partitioning this interconnect into 1 mm or shorter segments would result in the model containing more than 1,000 segments. Simulations utilizing such a large interconnect model would take an unacceptably long time to run. Consequently, what is needed is a method of modeling communication interconnects and other portions of circuits that result in reasonable simulation run times.

### SUMMARY OF THE INVENTION:

In one aspect, the present invention is directed to a method of characterizing a portion of an electrical circuit. The method comprises deriving a transfer function for the portion of the electrical circuit based on a measured response of the portion to a known input to the portion. A computer simulation is run as a function of the transfer function.

In another aspect, the present invention is directed to a method of creating a behavioral model of a printed circuit board communication interconnect. The method comprises deriving a transfer function for the communication interconnect based on a measured response of the communication interconnect to a known input to the communication interconnect. A computer simulation is run as a function of the transfer function.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a high-level schematic diagram of a conventional multi-chip system in which chips communicate with one another over a PCB communication interconnect;

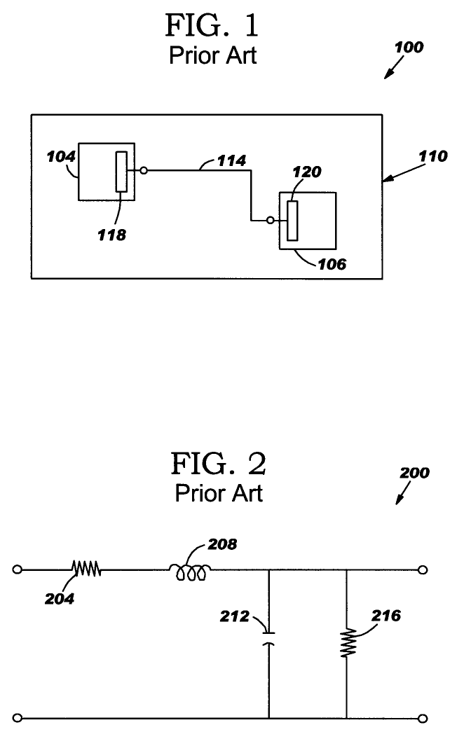

FIG. 2 is a schematic diagram illustrating a conventional circuit segment used to model transmission lines;

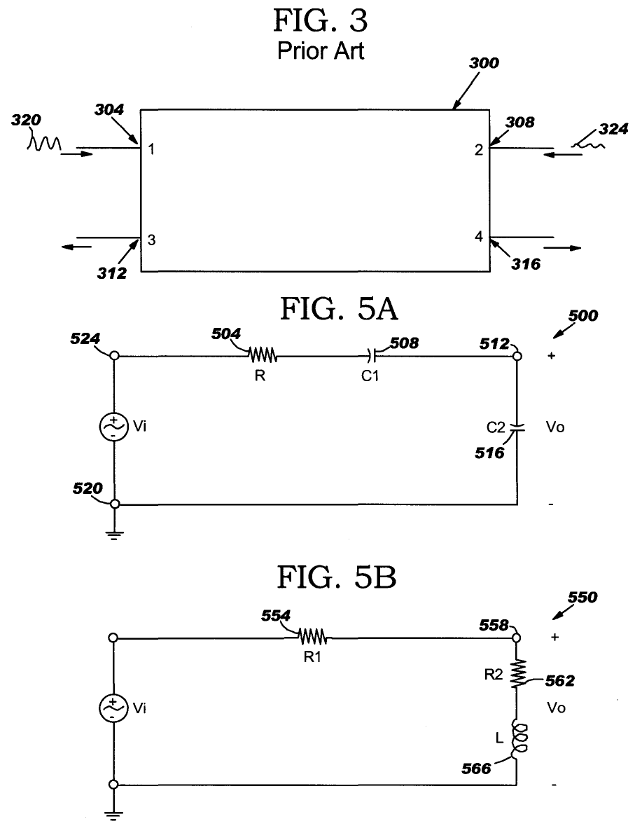

FIG. 3 is a high-level schematic diagram illustrating conventional S-parameter network analysis concepts;

FIG. 4 is a schematic diagram of an S-parameter modeling scheme of the present invention applied to a circuit portion;

FIG. 5A illustrates a voltage divider circuit segment that may be used to represent partial fractions PF1, PF2 and PF3 of FIG. 4; FIG. 5B illustrates a voltage divider circuit segment that may be used to represent partial fraction PF4 of FIG. 4;

FIGS. 6A, 6B, 6C and 6D show, respectively, plots of a unit step function input into the circuit portion of FIG. 4, the response of the transfer function representation of FIG. 4, the response of the partial fraction expansion representation of FIG. 4 and the elemental representation of the circuit portion of FIG. 4;

FIG. 7 is a plot showing the correlation between the measures S21 data from circuit portion of FIG. 4 and the elemental representation of FIG. 4;

FIG. 8 is a schematic diagram illustrating an alternative elemental representation of the circuit portion of FIG. 4;

FIG. 9 is a schematic diagram of a differential pair elemental representation of the circuit segment of FIG. 4;

FIGS. 10A is a transfer function representation of a PLL voltage regulator; FIG. 10B is a schematic diagram of an elemental representation of the transfer function of FIG. 10A and FIG. 10C is a plot showing the correlation between the measures S21 data from the PLL voltage regulator and the elemental representation of FIG. 10B; and

FIG. 11 is a flow diagram illustrating a behavioral modeling method of the present invention.

### DETAILED DESCRIPTION OF THE DRAWINGS

In general, the present invention is directed to modeling various portions of circuits (hereinafter “circuit portions”) using “elemental representations” containing resistive, inductive, capacitive and/or gain elements so that these circuit portions may be effectively and efficiently modeled using conventional simulation systems such as SPICE (“Simulation Program with Integrated Circuit Emphasis”), variants of SPICE and other conventional circuit simulation systems. As those skilled in the art will appreciate, the term “circuit portion” includes just that, any portion of a circuit, e.g., a communication interconnect, a phase locked loop voltage regulator or a power supply, among many others, or virtually any electromechanical system for which magnitude versus frequency data can be obtained. In addition, those skilled in the art will appreciate that a “circuit portion” need not be a discrete component such as those just mentioned. Rather, a circuit portion may include any number of discrete components and/or any number of interconnects between them. As will be apparent to those skilled in the art, generally all that is required is that the circuit portion have a measurable response to a known input.

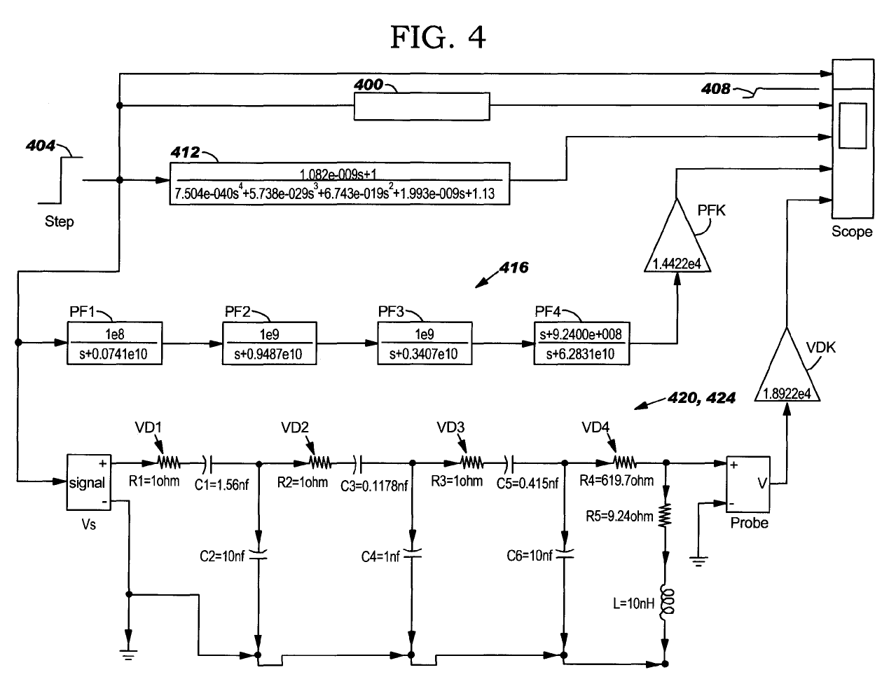

A convenient basis for creating an elemental representation of the present invention is to utilize scattering (S) parameter two-port network analysis. FIG. 3 illustrates the two-port network concept in connection with a circuit portion 300 having, in this example, a data input port (1) 304, a data output port (2) 308, an input ground (3) 312 and an output ground (4) 316. Sij, wherein i and j can be either “1” (i.e. port 1 (304)) or “2” (i.e., port 2 (308)), are the scattering parameters, which are the reflection and transmission coefficients between the incident and reflected waves. These scattering parameters describe the behavior of circuit portion 300 under linear conditions in the microwave frequency range. Each S-parameter is typically characterized by a magnitude, decibel and phase using a 50Ω terminated input or output, as the case may be. S11 is the input reflection coefficient; S21 is the forward transmission coefficient; S12 is the reverse transmission coefficient and S22 is the output reflection coefficient. It is noted that S21, i.e., the forward transmission coefficient, is the focus of the present disclosure since it describes the effect circuit portion 300 has on an input signal 320 as determined using an output signal 324. It is this effect that is typically most germane to simulation. However, it is noted that the present invention may be applied to the other S parameters.

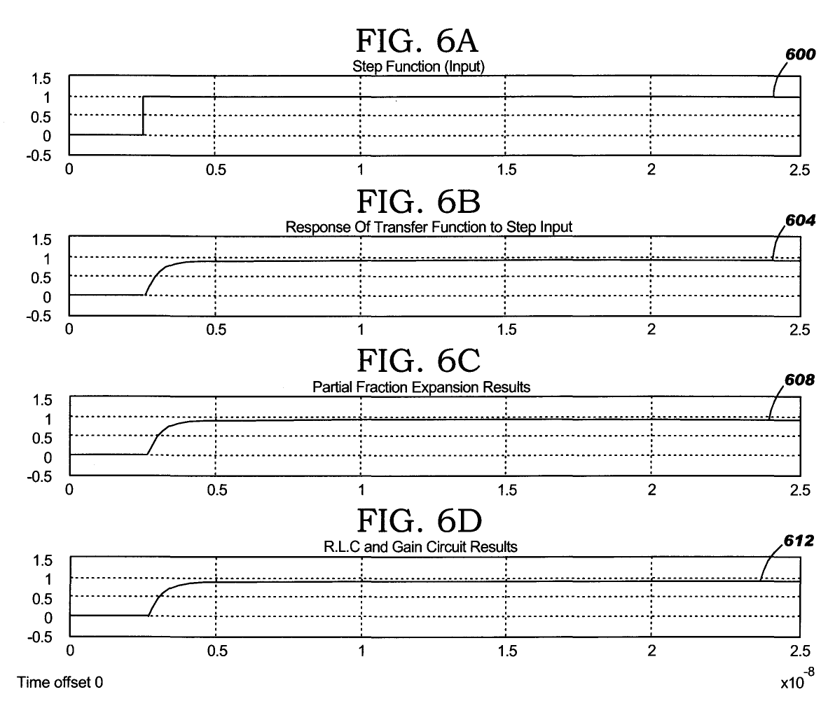

Referring to FIG. 4, since the measured S21 data corresponds to the effect that circuit portion 400 has on a known input signal 404, as determined by measuring the response, i.e., output signal 408 from the circuit portion, it is possible to represent S21 with a transfer function approximation, such as transfer function approximation 412. This is done using conventional techniques. Generally, however, a transfer function approximation may be made by successively adding a zero or a pole and iterating to compare the measured data with the “new” plot of the transfer function that results from adding the zero or pole.

Once a transfer function approximation 412 has been obtained, this approximation may be expanded using conventional partial fraction expansion techniques so as to obtain a partial fraction expansion 416 comprising partial fractions, such as partial fractions PF1, PF2, PF3 and PF4, and a partial fraction gain PFK. The partial fraction gain PFK may be scaled such that when the variable s approaches zero in each of partial fractions PF1-PF4, the value of each partial fraction is ≦1. Generally, partial fractions PF1-PF4 represent the poles and zeros of transfer function approximation 412. As discussed below, the number of poles and zeros, and therefore the number of partial fractions, considered in a model generally varies as a function of the design frequency of the circuit portion under consideration and the complexity of the effect that the circuit portion has on an input signal. In general, the higher the design frequency, the greater the number of partial fractions that need to be modeled. Similarly, the greater the complexity of the effect of the circuit portion on an input signal, the greater the number of partial fractions that need to be considered.

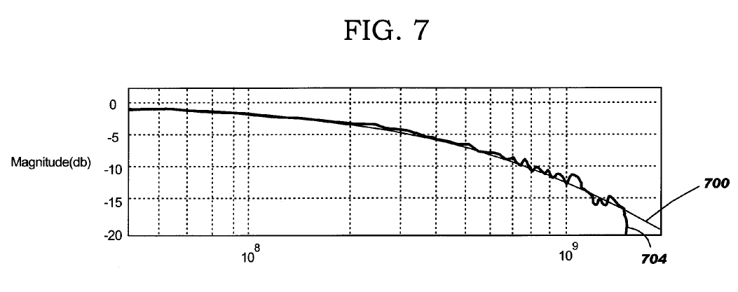

Partial fraction expansion 416 may be represented by an elemental representation 420, wherein each partial fraction, e.g., partial fraction PF1-PF4, may be modeled as a passive filter 424 comprising sub-filters each corresponding to a respective voltage divider circuit segment VD1, VD2, VD3, VD4 that contains resistive (R), inductive (L) and capacitive (C) elements, or subset thereof. For example, since partial fractions PF1-PF3 do not contain the “s” term in their numerators, each of these partial fractions may be represented by a voltage divider segment type 500 of FIG. 5A that includes a resistor 504 and capacitor 508 on one side of node 512 and a capacitor 516 on the other side of this node. It is noted that partial fractions PF1-PF3 are each in the form A/(s+P), where A and P are various constants.

For voltage divider type 500 having resistor 504 and capacitors 508, 516 as shown in 1,

$$\frac{Vo}{Vi} = \frac{\frac{1}{{sC}_{2}}}{R + \frac{1}{{sC}_{2}} + \frac{1}{{sC}_{1}}} \qquad ( 1 )$$

where Vo is the voltage across nodes 520, 524, Vi is the voltage across nodes 512, 524, R is the resistance of resistor 504, C1 is the capacitance of capacitor 508, C2 is the capacitance of capacitor 516 and s is Jω, where ω=2n(frequency). Factoring Equation {1} as follows,

$$\frac{\frac{1}{{sC}_{2}}}{R + \frac{1}{{sC}_{2}} + \frac{1}{{sC}_{1}}} = \frac{\frac{1}{{sC}_{2}}}{\frac{{sRC}_{1} {C}_{2} + {C}_{2} + {C}_{1}}{{sC}_{1} {C}_{2}}} = \frac{{C}_{1}}{{sRC}_{1} {C}_{2} + {C}_{2} + {C}_{1}} = \frac{\frac{{C}_{1}}{{RC}_{1} {C}_{2}}}{s + \frac{{C}_{2} + {C}_{1}}{{RC}_{1} {C}_{2}}} = \frac{\frac{1}{{RC}_{2}}}{s + \frac{{C}_{2} + {C}_{1}}{{RC}_{1} {C}_{2}}}$$

leads to the equation 2,

$$\begin{matrix}\frac{Vo}{Vi} = \frac{A}{s + P} \\ where \\ A = \frac{1}{{RC}_{2}} , \\ and & ( 3 ) \\ P = \frac{{C}_{2} + {C}_{1}}{{RC}_{1} {C}_{2}} . & ( 4 )\end{matrix}$$

Referring to FIG. 4, it is readily seen that each of partial fractions PF1-PF3 is in the form A/(s+P). Consequently, each of these partial fractions PF1-PF3 may be represented by determining values of A and P, by solving for R, C1 and C2 for Equations {3} and {4}, that correspond to the respective values in the partial fractions. Equations {3} and {4} provide two equations for solving three unknowns, i.e., R, C1 and C2. By selecting a value for one of these unknowns, Equations {3} and {4} can be solved for the remaining two unknowns. In the present example, this is done for each of partial fractions PF1-PF3 as follows.

For voltage divider segment VD1, a value of 10nf is selected for unknown C2 of capacitor 516 (FIG. 5A). The value selected is generally arbitrary because a behavioral model is at issue. Relative to the present example, capacitances are typically in the pico-farad range, inductances are typically in the nano-henry range and resistances are typically in the ohm range. Inputting A=1e⁸ and C2=10nf into Equation {3} and solving for unknown R results in R=1Ω. Then, P=0.074e^{8,} R1=1Ω and C2=10nf are input into Equation {4}. Equation {4} is then solved, resulting in C1=1.56nf.

Values for unknowns R2, C3 and C4 of voltage divider segment VD2 are similarly solved-for using Equations {3} and {4} (by substituting R2, C3 and C4 for R, C1 and C2, respectively) and the corresponding values of A and P of partial fraction PF2. In this case, a value of C4=1nf is arbitrarily selected. The result is that R2=1Ω and C3=0.1178nf. Similarly, the values for unknowns R3, C5 and C6 of voltage divider segment VD3 are determined using Equations {3} and {4} and partial fraction PF3. In the case of voltage divider segment VD3, a value of C6=1nf is arbitrarily selected for solving Equations {3} and {4}. Using the A and P values of partial fraction PF3, Equations {3} and {4} yield R3=1Ω and C5=0.415nf.

Partial fraction PF4 (FIG. 4), unlike partial fractions PF1-PF3, includes the “s” term in both its numerator and denominator and is in the general form (s+A)/(s+P). Consequently, to model partial fraction PF4 using a voltage divider circuit segment, it is necessary to use elements that provide the “s” term in the numerator. For example, partial fraction PF4 may be modeled using voltage divider segment type 550 of FIG. 5B that includes a resistor 554 on one side of node 558 and a resistor 562 and an inductor 566 on the other side of node 558. Voltage divider type 550 of FIG.

$$\begin{matrix}\frac{Vo}{Vi} = \frac{{R}_{1} + sL}{R + {R}_{1} + sL} = \frac{s + \frac{{R}_{1}}{L}}{s + \frac{R + R 1}{L}} = \frac{s + A}{s + P} \\ where & ( 5 ) \\ A = \frac{{R}_{1}}{L} , \\ and & ( 6 ) \\ P = \frac{R + {R}_{1}}{L} . & ( 7 )\end{matrix}$$

Again, there are two equations ({6} and {7}) and three unknowns (R4, R5 and L) for voltage divider segment VD4, such that a value for one of the unknowns can be (arbitrarily) selected in order to solve for the remaining two unknowns. In this example, L=10nH is selected. Inserting A=9.24e⁸ from partial fraction PF4 and L=10nH into Equation {6} and solving for R5 yields R5=9.24Ω. Then, inserting P=6.2831e10 from partial fraction PF4, L=10nH and R5=9.24Ω into Equation {7} and solving for R4 yields R4=619.7Ω.

With all of the values for R1-R5, C1-C6 and L determined, an appropriate value for the gain VDK for elemental representative 420 may be determined. Similar to partial fraction gain PFK discussed above, voltage divider gain may be scaled such that when the variable s approaches zero in each of partial fractions PF1-PF4, the value of each partial fraction is ≦1.

Once gain VDK has been determined, elemental representation 420 may be input into virtually any circuit simulation software, e.g., SPICE, HSPICE, etc., to determine how well the representation models the measured S12 data. As mentioned, each of voltage divider circuit segments VD1-VD4 is essentially a filter. The present inventors have observed that while partial fractions PF1-PF4 may appear in any order and still yield the same result, the order of the corresponding voltage divider circuit segments VD1-VD4 appear to provide better results when at least the first segment in the series is a high-pass filter. Thus, once each partial fraction PF1-PF4 has been represented by a corresponding voltage divider circuit segment VD1-VD4, it may be necessary to rearrange the segments to achieve the best model.

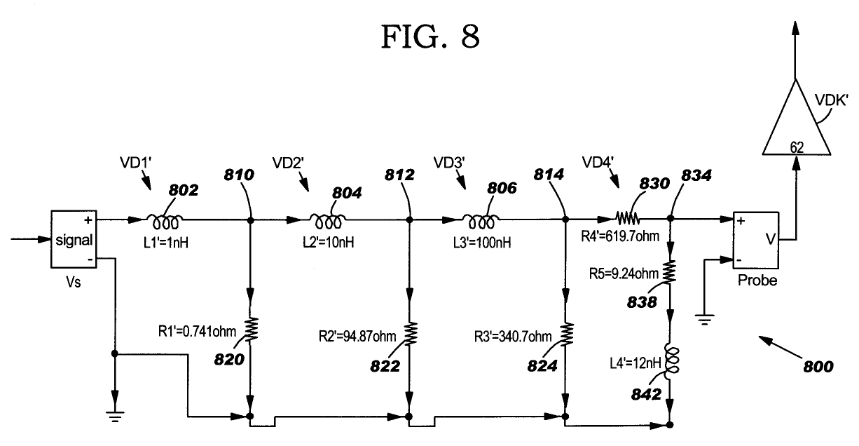

Referring to FIG. 4, the inventors ran simulations to determine the responses of transfer function approximation 412, partial fraction expansion 416 and elemental representation 420 to the step function 600 shown in FIG. 6A. The responses 604, 608, 612 of transfer function approximation 412, partial fraction expansion 416 and elemental representation 420 to step input 600 are shown in FIGS. 6B, 6C and 6D, respectively. Referring to FIGS. 6A-6D, and also to FIG. 4, FIGS. 6B-6D show that all three responses 604, 608, 612 correlate highly with one another, and, importantly, response 612 of elemental representation 420 correlates very well with response of transfer function approximation 412. This high correlation indicates that elemental representation 420 provides a good model of circuit portion 400.

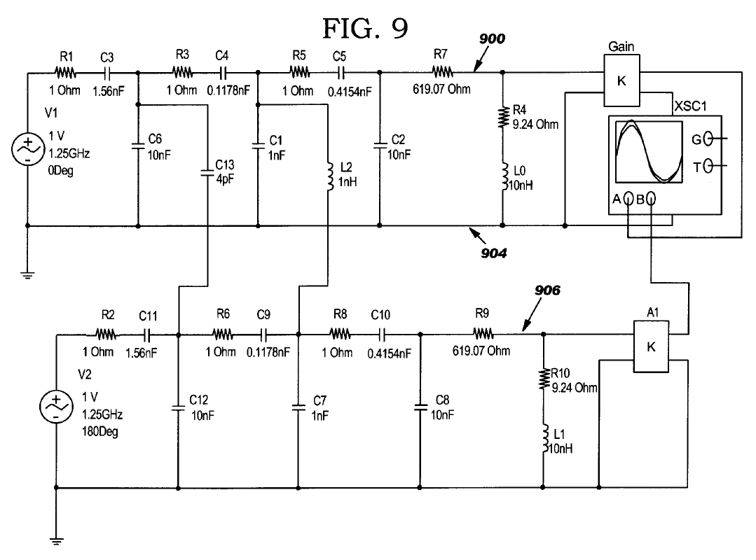

Referring to FIG. 7, and also to FIG. 4, FIG. 7 shows plots of the magnitude versus frequency for the actual response 700, i.e., the measured S21 data, of circuit portion 400 and the simulated response 704 of elemental representation 420. These plots show that, for elemental representation 420 containing four voltage divider segments VD1-VD4, there is a very good correlation between the responses 700, 704 at lower frequencies, but a degrading correlation as the frequency becomes higher. Generally, for this example, the lower correlation at higher frequencies is not a problem, since the magnitude of the response has degraded more than 15 dB relative to the input signal. For most applications, this would not be acceptable. Consequently, circuit portion 400 would not be suitable for higher frequency applications. That said, if it is desired that simulated response 704 of the elemental representation correlate better with measured response 700, in this case at higher frequencies, the number of poles and zeros portrayed in the elemental representation can be increased by increasing the number of partial fractions used in the partial fraction expansion of transfer function approximation 412.

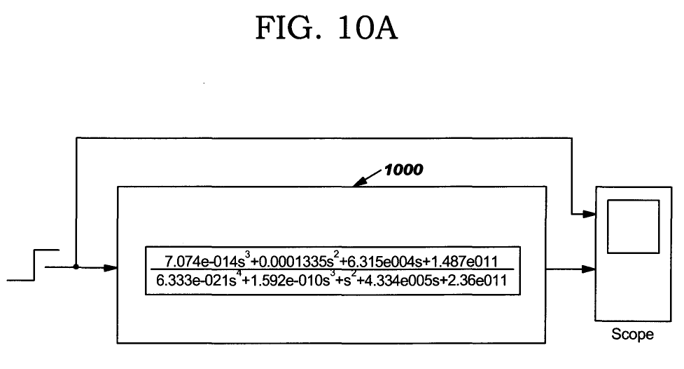

FIG. 4 illustrates one elemental representation 420 of circuit portion 400 that contains two voltage divider segment types 500, 550 as shown in FIGS. 5A and 5B, respectively. However, those skilled in the art will readily appreciate that other voltage divider segment types may be used to model the same partial fractions PF1-PF4. For example, as shown in FIG. 8 partial fractions PF1-PF3 (FIG. 4) can be represented by an elemental representation 800 comprising voltage divider segments VD1′-VD3′ that each contain an inductor 802, 804, 806 on one side of the corresponding node 810, 812, 814 and a resistor 820, 822, 824 on the other side of that node. Partial fraction PF4 (FIG. 3) can be modeled by voltage divider segment VD4′ that includes a resistor 830 on one side of node 834 and a resistor 838 and an inductor 842 on the other side of node 834. FIG. 8 shows the values L1′-L4′ and R1′-R5′ corresponding to partial fractions PF1-PF4 of FIG. 4. These values may be obtained in a manner similar to the manner described above in connection with voltage divider segments VD1-VD4 of FIG. 4. Similarly, gain VDK′ can be obtained in the manner described above.

Although not shown, in alternative implementations each of voltage divider segments VD1′-VD3′ need not be modeled with the same voltage divider segment type. For example, VD1′ and VD3′ may be as shown in FIG. 8, but VD2′ may be of type 500 shown in FIG. 5A, or vice versa, for example. Those skilled in the art will appreciate the variety of voltage divider segment types and arrangements thereof that may be used to create an elemental representation of the present invention.

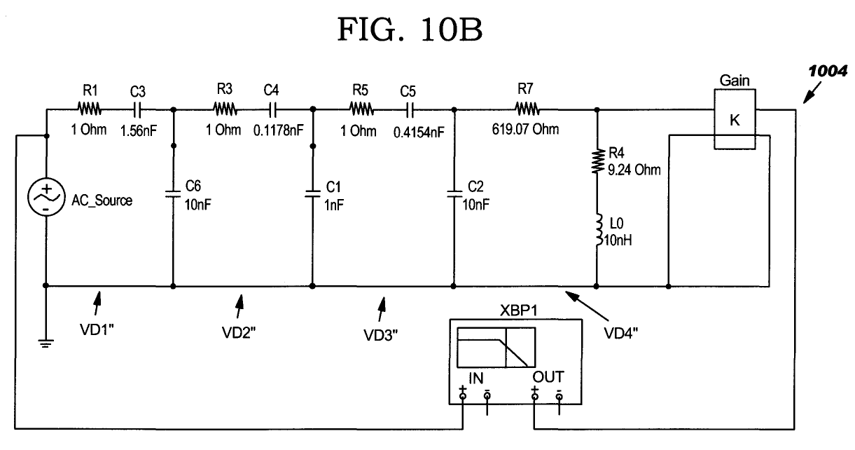

FIG. 9 shows an elemental representation 900 of a differential-pair type PCB communication interconnect (not shown) that contains first and second representation portions 904, 906 that represent the differential pair. Differential-pair circuit segments are often used in low-voltage signal applications. The capacitive and inductive coupling between first and second representation portions 904, 906 can be determined by 3D simulation of the PCB that takes into account the materials and dielectric characteristics of the PCB.

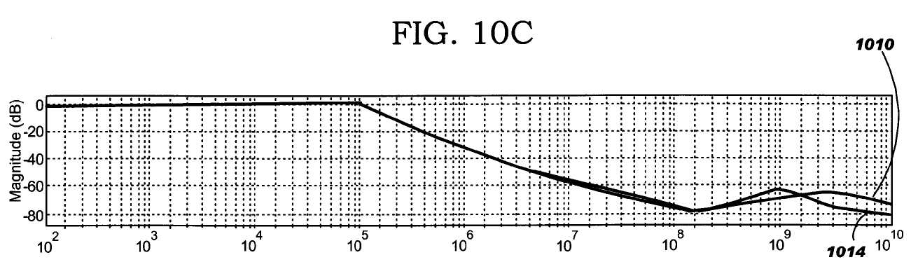

As mentioned above, the present invention can be implemented in connection with not only communication interconnects, but virtually any circuit portion. FIGS. 10A-10C illustrate an application of the present invention to a conventional PLL voltage regulator (not shown). FIG. 10A shows a transfer function approximation 1000 derived from measured S21 data (not shown) from the voltage regulator. FIG. 10B illustrates an elemental representation 1004 of transfer function approximation 1000 of FIG. 10A that is derived in a manner similar to the manner described above in connection with the derivation of elemental representation 420 of FIG. 4. That is, first transfer function approximation 1000 of FIG. 10A may be expanded into a series of partial fractions (not shown) and a partial fraction gain PFK (not shown). Then, as illustrated in FIG. 10B, each partial fraction may be represented as a voltage divider circuit segment VD1″-VD4″ and a voltage divider gain VDK. It is noted that the fact that there are four voltage divider segments VD1″-VD4″ in elemental representation 1004 and four voltage divider segments VD1-VD4, VD1′-VD4′ in each of elemental representations 420, 800 of FIGS. 4 and 8, respectively, is coincidental. As those skilled in the art will appreciate, an elemental representation of the present invention may certainly have more or fewer than four voltage divider segments.

FIG. 10C contains plots of the magnitude versus frequency for the actual response 1010, i.e., an AC sweep, of the voltage regulator and the simulated response 1014 of elemental representation 1004 of the regulator. Plots show that, for elemental representation 1004 containing four voltage divider segments VD1″-VD4″, there is an excellent correlation between responses 1010, 1014 at all but an upper range of frequencies. Similar to the situation described above in connection with FIG. 7, if it is desired that the response of the elemental representation correlate better with measured response, in this case at higher frequencies, the number of poles and zeros portrayed in the elemental representation can be increased by increasing the number of partial fractions used in the partial fraction expansion of transfer function approximation 1000 of FIG. 10A.

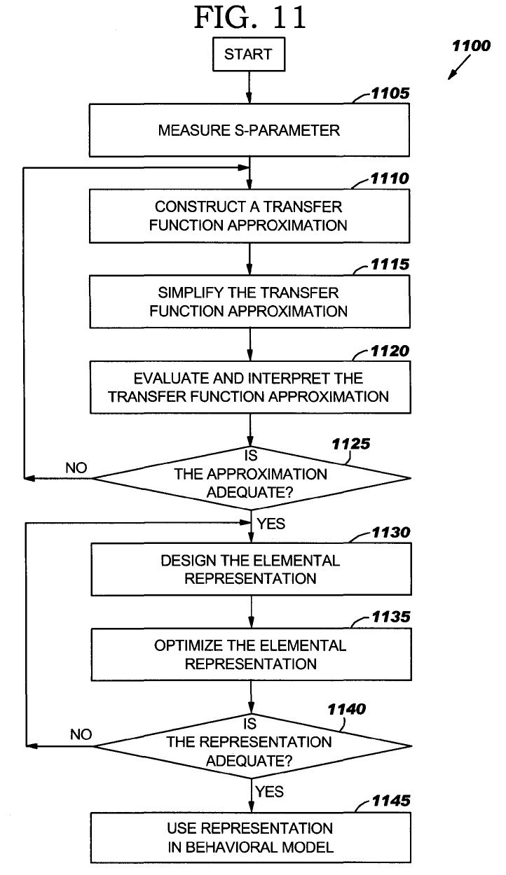

Referring to FIG. 11, and also to FIG. 4, FIG. 11 illustrates a behavioral model generating method 1100 of the present invention that may be used to create a behavioral model of a portion of a circuit, such as circuit portion 400, the PLL voltage regulator discussed above in connection with FIGS. 10A-10C or virtually any other portion of a circuit. At step 1105, an S-parameter of the physical circuit portion under consideration is measured using conventional procedures. For example, if the S21 parameter is at issue, the response of the circuit portion to a known input is measured. Then, at step 1110, a transfer function approximation, such as transfer function approximation 412, is constructed from the measured S-parameter data collected at step 1105.

At step 1115, the transfer function approximation is simplified by expanding it into a plurality of partial fractions e.g., partial fractions PF1-PF4, using conventional partial fraction expansion techniques. Following the partial fraction expansion, the series of partial fractions may be evaluated and interpreted at step 1120 to determine if the transfer function adequately represents the circuit portion under consideration. In evaluating and interpreting the series of partial fractions, the transfer function may be assessed in terms of its stability and oscillatory behavior at steady state.

At step 1125, a decision is made as to whether or not the transfer function adequately represents the measured S-parameter data. If not, method 1100 may return to step 1110 to construct a new transfer function approximation. A new transfer function may be constructed, e.g., by moving one or more poles and zeros to different locations on a complex plane and/or adding one or more new poles and zeros.

On the other hand, if the transfer function approximation, and consequently the partial fractions, sufficiently represent the measured S-parameter data, method 1100 may proceed to the design of an elemental representation, e.g., elemental representation 420, of the partial fractions at step 1130. For example, as discussed above in detail, the partial fraction expansion may be represented as passive filter 424 comprising a series of sub-filters, or voltage divider circuit segments, e.g., voltage divider segments VD1-VD4, and a voltage divider gain, e.g., gain VDK. As also discussed, each of the voltage divider segments may include a combination of resistive, inductive and capacitive elements. Resistance, inductance and capacitance values for these elements may be derived from the partial fractions, again, as discussed above in detail.

Once the elemental representation has been designed, the representation may be optimized at step 1135. For example, if the elemental representation comprises a series of voltage dividers and a voltage divider gain as in the example of FIG. 4, this representation may be optimized by rearranging the voltage dividers, i.e., filters, and adjusting the voltage divider gain as needed to achieve the best results. After the elemental representation has been optimized, a decision is made at step 1140 as to whether or not the representation is adequate for the behavioral model. If not, method 1100 may return to step 1130 at which a new elemental representation is designed. For example, in the context of a voltage divider representation, a new elemental representation may include providing each voltage divider circuit segment with different combinations of resistive, inductive and capacitive elements. On the other hand, if the elemental representation is deemed adequate, it may be implemented at step 1145 in the behavioral model.

The present invention is useful in a number of applications. For example, in the context of the printed circuit boards (see, e.g., the example discussed in the Background section above), a method of the present invention, such as method 1100 of FIG. 11, may be used to create a behavioral model of the communication interconnects on the circuit board that can be used in a simulation environment, e.g., SPICE, HSPICE, etc., to characterize the interconnects. For example, modeling the communication interconnects in a simulation environment as an elemental representation allows engineers and designers to analyze signal integrity and noise in the printed circuit board. Of course, those skilled in the art will recognize that there are other applications for the present invention. For example, as mentioned above, the present invention can be used to create behavioral models for virtually any type of electrical and electromechanical system for which magnitude versus frequency data can be obtained.

Although the invention has been described and illustrated with respect to an exemplary embodiment thereof, it should be understood by those skilled in the art that the foregoing and various other changes, omissions and additions may be made therein and thereto, without parting from the spirit and scope of the present invention.

What is claimed is:

1. A method of characterizing a portion of an electrical circuit, comprising:
a) deriving a transfer function for the portion of the electrical circuit based on a measured response of the portion to a known input to the portion; and
b) running a computer simulation as a function of said transfer function.

2. A method according to claim 1, further comprising the step of deriving a partial fraction expansion of said transfer function, step b) including running a computer simulation as a function of said partial fraction expansion.

3. A method according to claim 2, further comprising the step of creating an elemental representation of said partial fraction expansion, step b) including running a computer simulation using said elemental representation.

4. A method according to claim 3, wherein said partial fraction expansion includes a plurality of partial fractions, the step of creating said elemental representation includes representing each of said partial fractions as a circuit segment.

5. A method according to claim 4, wherein the step of representing each of said partial fractions as a circuit segment includes representing each of said circuit segments as a voltage divider.

6. A method according to claim 4, wherein the step of representing each of said partial fractions as a circuit segment includes representing each of said circuit segments as a filter.

7. A method according to claim 3, wherein the step of creating an elemental representation of said partial fraction expansion includes representing said elemental representation as a plurality of circuit segments.

8. A method according to claim 7, wherein the step of representing said elemental representation as a plurality of circuit segments includes representing said elemental representation with at least one gain element.

9. A method according to claim 1, wherein the portion of the circuit comprises a communication interconnect and step a) includes deriving a transfer function for the communication interconnect based on a measured response of the communication interconnect to a known input to the communication interconnect.

10. A method of converting S-parameter data to an elemental approximation, comprising: a) deriving a transfer function from the S-parameter data; and b) representing said transfer function as an elemental representation.

11. A method according to claim 10, wherein step b) includes the steps of expanding said transfer function into a plurality of partial fractions and representing each of said partial fractions as a circuit segment.

12. A method according to claim 11, wherein the step of representing each of said partial fractions as a circuit segment includes representing each of said circuit segments as a voltage divider.

13. A method according to claim 11, wherein the step of representing each of said partial fractions as a circuit segment includes representing each of said circuit segment as a filter.

14. A method according to claim 13, wherein each of said filters has filtering ability, the method further comprising ordering said filters as a function of said filtering ability.

15. A method according to claim 10, wherein step b) includes representing said transfer function as a plurality of circuit elements, wherein at least one of said circuit elements is a gain element.

16. A method of creating a behavioral model of a printed circuit board communication interconnect, comprising: a) deriving a transfer function for the communication interconnect based on a measured response of the communication interconnect to a known input to the communication interconnect; and b) running a computer simulation as a function of said transfer function.

17. A method according to claim 16, further comprising the step of deriving a partial fraction expansion of said transfer function, step b) including running a computer simulation as a function of said partial fraction expansion.

18. A method according to claim 17, wherein said partial fraction expansion includes a plurality of partial fractions, the method further including the step of representing each of said partial fractions as a circuit segment.

19. A method according to claim 18, wherein the step of representing each of said partial fractions as a circuit segment includes representing each of said circuit segments as a voltage divider.

20. A method according to claim 18, wherein the step of representing each of said partial fractions as a circuit segment includes representing each of said circuit segments as a filter.
